(19) United States
(12) Patent Application Publication
(10) Pub. No.: US 2008/0181136 A1
(43) Pub. Date: Jul. 31, 2008

(54) MEDIUM HAVING RECORDED THEREIN NETWORK CONFIGURATION VERIFICATION PROGRAM, NETWORK CONFIGURATION VERIFICATION METHOD, AND NETWORK CONFIGURATION VERIFICATION APPARATUS

(75) Inventors: Yukihiro WATANABE, Kawasaki (JP); Kuniaki Shimada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/018,626

(22) Filed: Jan. 23, 2008

(30) Foreign Application Priority Data
Jan. 24, 2007 (JP) 2007-13863

(51) Int. Cl. H04L 12/28

(52) U.S. Cl. 370/255; 370/254; 709/220

(57) ABSTRACT

A topology design information generator which, based on design information storing setting information, which is set in each communication instrument in order to enable the communication, on a layer-by-layer basis, generates layer-by-layer topology design information of the network. A topology information generator which collects the layer-by-layer setting information actually set in each communication instrument and, based on the collected setting information, generates layer-by-layer topology information of the actually constructed network. And a topology information comparator which compares the topology design information generated by the topology design information generator, and the topology information generated by the topology information generator, on the layer-by-layer basis.

### BACKGROUND

1. Field of the Invention

The invention relates to a medium having recorded therein a network configuration verification program, a network configuration verification method, and a network configuration verification apparatus, which verify topologies of a network configured by connecting a plurality of communication instruments which carry out a communication using a communication protocol hierarchized in a plurality of layers.

2. Description of the Related Art

Recently, it has become more difficult to comprehend a configuration of a physical connection and logical connection of communication instruments configuring a network (hereafter, referred to as a “topology”)in an information technology (IT) system due to the growing scale and complexity of IT systems.

Most of the costs of designing an IT system are labor costs associated with manual operations. For this reason, in IT systems, there have been higher and higher costs involved in design and construction of the network

For example, parameters set in the communication instruments may be set erroneously due to a design error or the like during the design of an IT system network. If the error is found after the network construction, it results in an occurrence of a return to a design phase and of a verification operation after a redesign, and high costs are incurred by these operations.

Also, an operation, such as an instrument setting or a cable connection, may be carried out by a person during the design of an IT system network. However, in the event that a worker carries out an erroneous operation in the cable connection operation, the network does not operate. In this case, the worker or a person in charge of the network construction needs to identify a cause of the network not operating. However, special know-how with an experience and knowledge of the worker or the person in charge of the network construction is required to identify the cause, and finding a solution requires a great deal of time and labor.

In order to prevent this kind of error, a tool which supports a verification at the design time by simulating behavior of the constructed network based on designed parameters, and confirming a validity of the parameters, has been provided in the market (for example, “CCNA Router and Network Simulator-Free Exam Prep”, [retrieved on Dec. 26, 2004], internet <URL:http://www.routersim.com/CCNA5_Home.html>, and “MIMIC Simulator”, [retrieved on Dec. 26, 2004], internet <http://www.gambitcomm.com/site/products/japanese/jpmimic_simulator.shtml>).

Apart from this, for example, JP-A-2002-185512 discloses a method which collects network setting information from a constructed network, reflects it in a virtual network constructed on a verification server and, by artificially carrying out a setting change for such a virtual network, verifies the changed setting information.

However, the heretofore described related art, being one which carries out a simulation, limiting it to behavior of a single communication instrument, or behavior of a specific service and protocol has a problem in that it is not possible to comprehensively verify a whole of the network.

Particularly, in a network configured of communication instruments which carry out a communication using a communication protocol hierarchized in a plurality of layers, as an upper layer data accessibility depends on a lower layer data accessibility, it is necessary to comprehensively carry out the verification after comprehending a topology of each layer.

Furthermore, after a network operation is started, there is a case in which a configuration change which is unexpected by a network manager occurs due to an occurrence of a failure, an unauthorized addition by a network user of the instrument, or the like. In this kind of case, the network user needs to swiftly identify a place changed on the network.

For this reason, the network manager, even after the network operation is started, needs to constantly monitor the network, and verify whether or not a topology is changed on a layer-by-layer basis.

### SUMMARY

According to an aspect of an embodiment, a medium has recorded therein a network configuration verification program that causes a computer to execute the following processes:

a. a topology design information generation procedure that generates layer-by-layer topology design information of a network based on design information storing setting information. The design information storing setting information is set in each communication instrument in order to enable a communication on a layer-by-layer basis.

b. a topology information generation procedure which collects the layer-by-layer setting information actually set in each communication instrument and generates layer-by-layer topology information of the actually constructed network based on the collected setting information.

c. a topology information comparison procedure which compares the topology design information generated by the topology design information generation procedure to the topology information generated by the topology information generation procedure on the layer-by-layer basis.

The above-described embodiments of the present invention are intended as examples, and all embodiments of the present invention are not limited to including the features described above.

### BRIEF DESCRIPTION OF THE DRAWINGS

FIG. 1 is a diagram showing a model of a multilayer topology;

FIG. 2 is a diagram showing model elements of the topology;

FIG. 3 is a diagram for illustrating an outline and configuration of a network configuration verification apparatus according to an embodiment;

FIG. 4 is a functional block diagram showing a configuration of a design time topology calculator;

FIG. 5 is a diagram for illustrating design information;

FIG. 6 is a diagram for illustrating physical connection information;

FIG. 7 is a diagram for illustrating a design time topology;

FIG. 8 is a diagram showing an example of instrument setting information;

FIG. 9 is a diagram showing an example of physical/logical connection information;

FIG. 10 is a functional block diagram showing a configuration of a post construction topology calculator;

FIG. 11 is a functional block diagram showing a configuration of a topology comparator;

FIG. 12 is a diagram for illustrating a difference extraction process carried out by a difference extractor;

FIG. 13 is a diagram showing an example of topology difference information;

FIGS. 14A and 14B are diagrams for illustrating a principle of identifying a causative place by means of a cause identification and person-in-charge extraction portion;

FIG. 15 is a flowchart showing a processing procedure of the design time topology calculator;

FIG. 16 is a flowchart showing a processing procedure of an STP dynamic configuration calculation;

FIG. 17 is a flowchart showing a processing procedure of a VTP dynamic configuration calculation;

FIG. 18 is a flowchart showing a processing procedure of an HSRP dynamic configuration calculation;

FIG. 19 is a flowchart showing a processing procedure of the topology comparator;

FIG. 20 is a flowchart showing a processing procedure of an own layer difference extraction process shown in FIG. 19;

FIG. 21 is a flowchart showing a processing procedure of a cause identification and person-in-charge extraction process shown in FIG. 19; and

FIG. 22 is a functional block diagram showing a configuration of a computer which executes a network configuration verification program according to the embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Hereafter, a detailed description will be given of a preferred embodiment, with reference to the accompanying drawings. In the embodiment, an object is to provide a network configuration verification program, a network configuration verification method and a network configuration verification apparatus which, by verifying topologies on the layer-by-layer basis, can comprehensively verify the whole network.

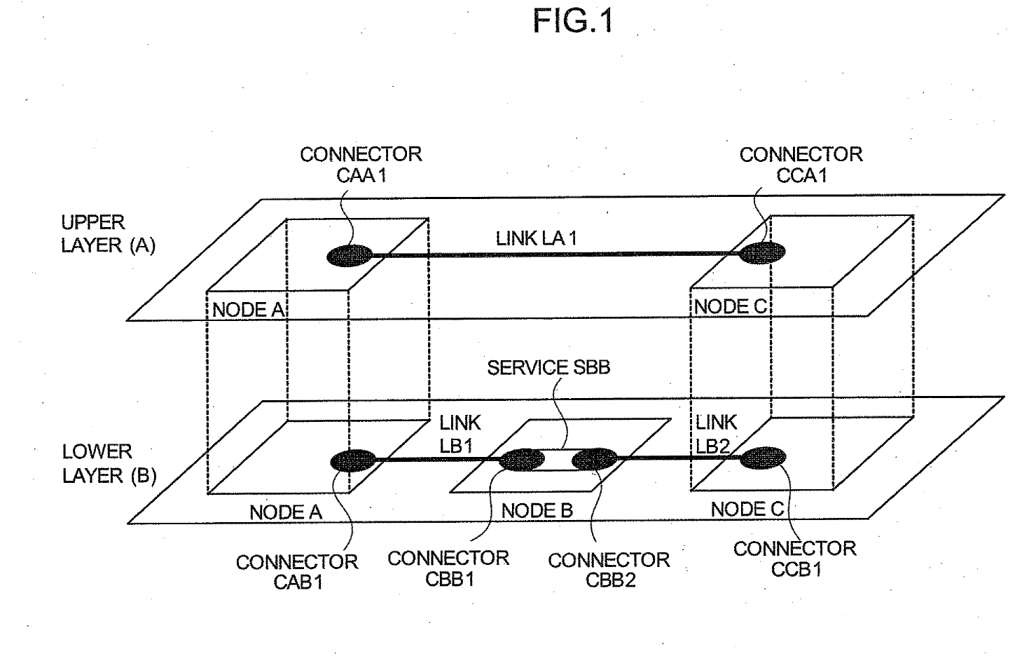

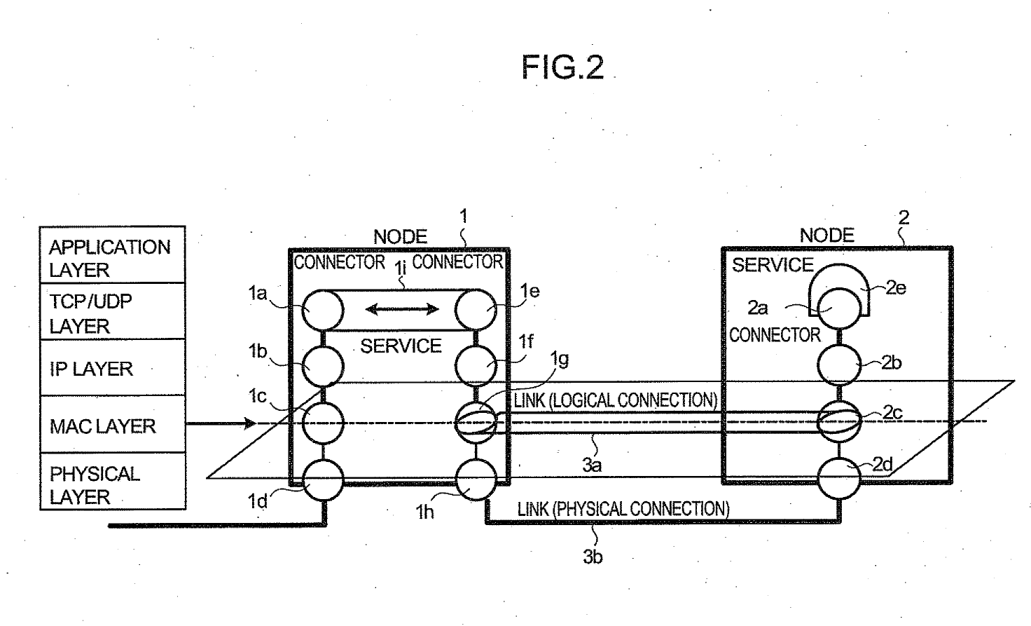

First, a description will be given of a concept of topology information (physical/logical connection information) generated by the network configuration verification apparatus of the embodiment. FIG. 1 is a view showing a model of a multilayer topology, and FIG. 2 is a diagram showing model elements of the topology. In the model shown in both figures, the topology is represented by three simple elements: a “link” for a physical connection or a logical connection between communication instruments in each layer, a “connector” for a communication instrument physical or logical interface used in the link, and a “service” which carries out a data exchange between a plurality of the connectors in each communication instrument.

Specifically, in the model shown in FIG. 1, an upper layer a has nodes A and C, and a lower layer b has nodes A, B and C. Herein, in the upper layer a, a connector CAa1 of the node A and a connector CCa1 of the node C are connected by a link La1. Also, in the lower layer b, a connector CAb1 of the node A and a connector CBb1 of the node B are connected by a link Lb1, a connector CBb2 of the node B and a connector CCb1 of the node C are connected by a link Lb2, and a service SBb is interposed between the connector CBb1 and connector CBb2 of the node B.

Also, in the model shown in FIG. 2, layers of a data communication carried out in the network are categorized into a physical layer, an MAC layer, an IP layer, a TCP/UDP layer and an application layer. Herein, connectors 1a and 1e of a node 1 and a connector 2a of a node 2 are connectors of the TCP/UDP layer, a service 1i is a service which carries out a data transfer between the connectors of the TCP/UDP layer, and a service 2e is a service which carries out a termination of the communication in the TCP/UDP layer.

Connectors 1b and 1f of the node 1 and a connector 2b of the node 2 are connectors of the IP layer. Connectors 1c and 1g of the node 1 and a connector 2c of the node 2 are connectors of the MAC layer, and the connector 1g and the connector 2c are logically connected by a link 3a of the MAC layer.

Connectors 1d and 1h of the node 1 and a connector 2d of the node 2 are connectors of the physical layer, and the connector 1h and the connector 2d are physically connected by a link 3b of the physical layer.

In this way, by the network configuration verification apparatus displaying the physical and logical connections between the communication instruments in a certain layer as a setting of a repeater in the layer and a collection (a group) of connections in a lower layer, it is possible for an IT system manager to, by confirming this display, correlate and manage topology information of the lower layer and a topology of an upper layer.

It is presupposed that all the physical/logical connection information (physical/logical connection information included in a design time topology 30, a post construction topology 40 and an operation time topology 50, to be described hereafter) generated by the network configuration verification apparatus according to the embodiment is generated in line with the heretofore described model, and that a data generation method disclosed in JP-A-2005-348051 is used as a method which generates such physical/logical connection information.

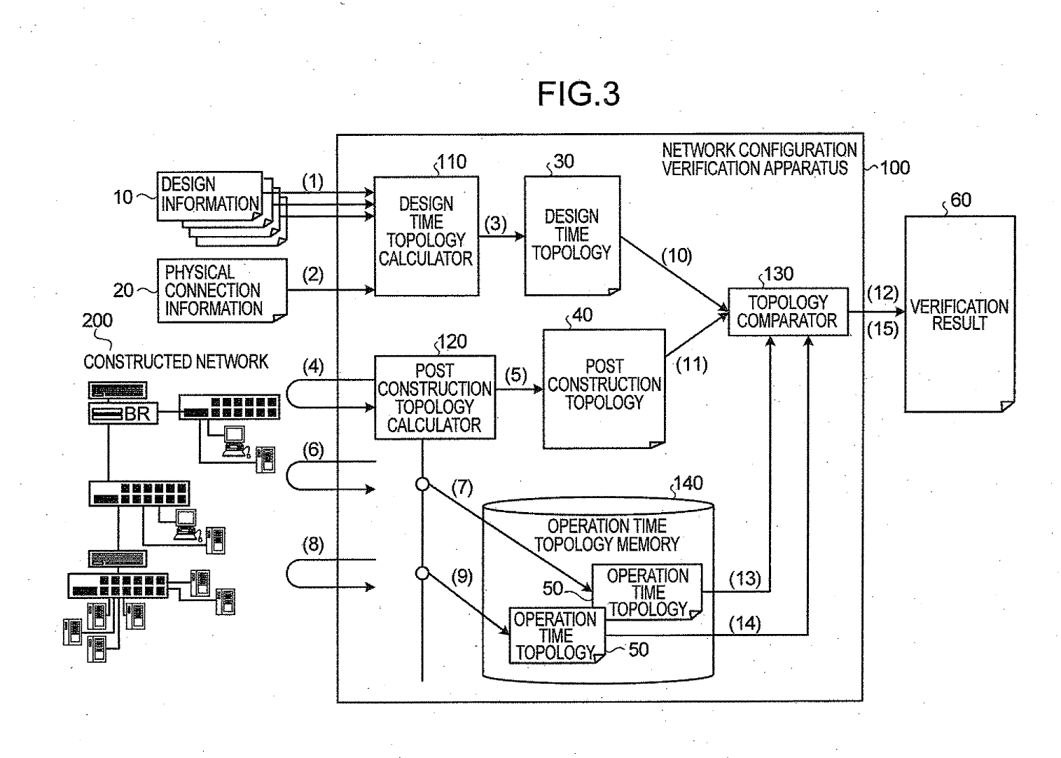

Next, a description will be given of an outline and configuration of the network configuration verification apparatus according to the embodiment. FIG. 3 is a diagram for illustrating the outline and configuration of the network configuration verification apparatus according to the embodiment. The network configuration verification apparatus according to the embodiment is an apparatus which verifies topologies of a network configured by connecting a plurality of communication instruments which carry out a communication using a communication protocol hierarchized in a plurality of layers. As shown in FIG. 3, the network configuration verification apparatus 100 has a design time topology calculator 110, a post construction topology calculator 120, a topology comparator 130, and an operation time topology memory 140.

The design time topology calculator 110 is a processor which, based on design information determined at a design time, generates design time topology information. Specifically, the design time topology calculator 110 acquires design information 10 including layer-by-layer instrument setting information set in each communication instrument in order to enable the communication, or like information (refer to 1 in FIG. 3), and physical connection information 20 which is physical connection information of each communication instrument (refer to 2 in the same figure). Based on the acquired information, it generates the instrument setting information and physical/logical connection information set in the network, on the layer-by-layer basis, and transmits the generated information as a design time topology 30 (refer to 3 in the same figure).

The post construction topology calculator 120 is a processor which collects setting information from each communication instrument connected to the constructed network and, based on the collected setting information, generates post construction topology information. Specifically, the post construction topology calculator 120 collects the layer-by-layer instrument setting information and physical connection information from the communication instruments connected to the constructed network 200 (refer to 4 in the same figure). Based on the collected setting information, it generates the instrument setting information and physical/logical connection information of the constructed network on the layer-by-layer basis, and transmits the generated information as the post construction topology 40 (refer to 5 in FIG. 3).

Also, the post construction topology calculator 120, after the network operation is started, collects the layer-by-layer instrument setting information and physical connection information from the communication instruments connected to the constructed network 200 in a predetermined cycle (refer to 6 and 8 in FIG. 3), generates the instrument setting information and the physical/logical connection information on the layer-by-layer basis, and stores each item of information generated at each of a plurality of time points, as an operation time topology 50, in the operation time topology memory 140 (refer to 7 and 9 in FIG. 3).

The topology comparator 130 is a processor which compares the design time topology and the post construction topology, and transmits a result of the comparison as a verification result. Specifically, the topology comparator 130 acquires the design time topology 30 (refer to 10 in FIG. 3) generated by the design time topology calculator 110 and the post construction topology 40 (refer to 11 in FIG. 3) generated by the post construction topology calculator 120, and compares the individual acquired items of topology information on the layer-by-layer basis. Then, in the event that a mismatch has occurred in the topology information, the topology comparator 130 identifies a communication instrument or a place which has caused the mismatch, and transmits the identified communication instrument or place as the verification result 60 (refer to 12 in FIG. 3).

Also, the topology comparator 130 sequentially reads the operation time topologies 50 stored in the operation time topology memory 140 (refer to 13 and 14 in FIG. 3), and compares the operation time topologies 50 at two consecutive time points. Then, in the event that a mismatch has occurred in the topology information, the topology comparator 130 identifies the communication instrument or place which has caused the mismatch, and transmits the identified communication instrument or place as the verification result 60 (refer to 15 in FIG. 3).

In this way, the network configuration verification apparatus 100 according to the embodiment is arranged in such a way as to, based on the layer-by-layer design information 10 and physical connection information 20 set in the communication instruments, generate the layer-by-layer design time topology 30 of the network, collect the layer-by-layer setting information actually set in each communication instrument, based on the collected setting information, generate the layer-by-layer post construction topology 40 of the actually constructed network 200, and compare the design time topology 30 and the post construction topology 40 on the layer-by-layer basis.

Also, the network configuration verification apparatus 100 according to the embodiment is arranged in such a way as to collect the layer-by-layer setting information actually set in each communication instrument, based on the collected setting information, generate the layer-by-layer operation time topology 50 of the actually constructed network, and furthermore, re-collect the setting information, based on the re-collected setting information, regenerate the layer-by-layer operation time topology 50, and compare the individual generated items of topology information on the layer-by-layer basis.

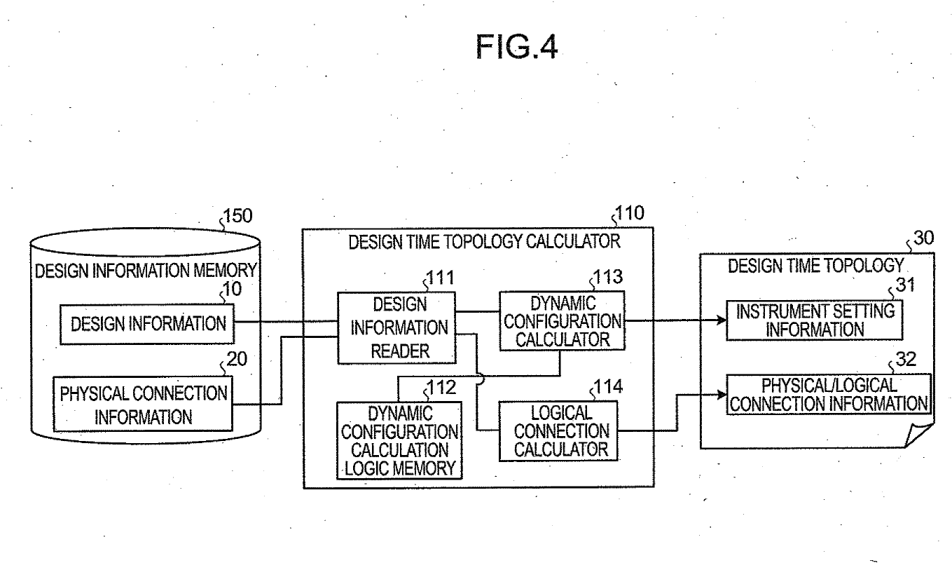

Next, a description will be given of a configuration of the design time topology calculator 110 shown in FIG. 3. FIG. 4 is a functional block diagram showing the configuration of the design time topology calculator 110. As shown in FIG. 4, the design time topology calculator 110, being connected to a design information memory 150, has a design information reader 111, a dynamic configuration calculation logic memory 112, a dynamic configuration calculator 113 and a logical connection calculator 114. The design information 10 and the physical connection information 20 are stored in the design information memory 150.

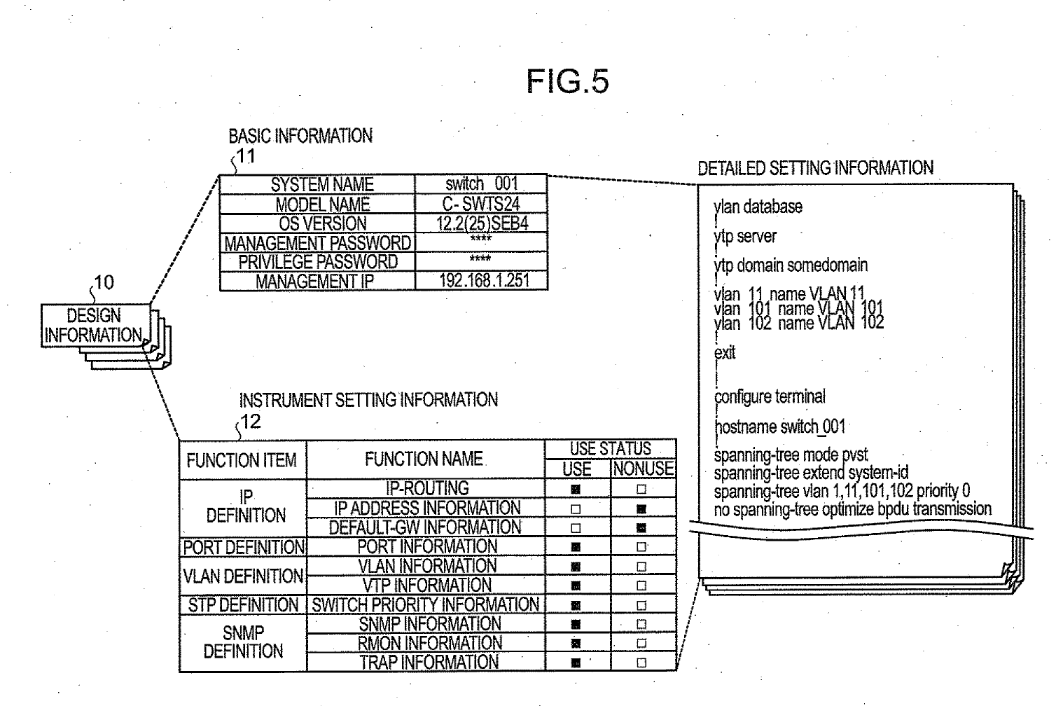

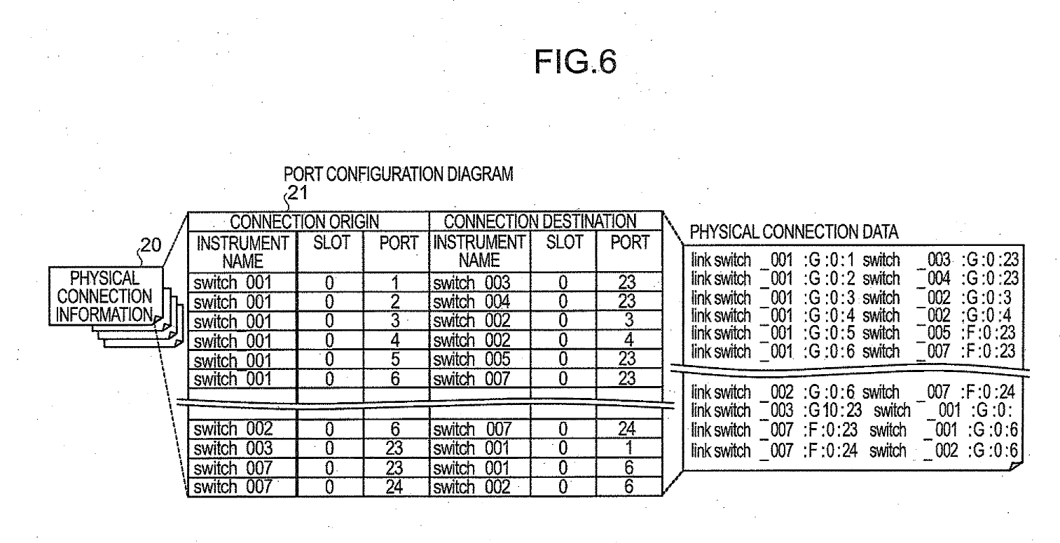

The design information reader 111 is a processor which reads the design information 10 and the physical connection information 20 from the design information memory 150. Herein, a description will be given of the design information 10 and the physical connection information 20. FIG. 5 is a diagram for illustrating the design information 10, and FIG. 6 is a diagram for illustrating the physical connection information 20.

The design information lb, being setting information of each communication instrument necessary for the network construction, specifically, is configured of basic information 11 and instrument setting information 12, as shown in FIG. 5. Of these, the basic information 11, being basic setting information set in the communication instruments, is configured of, for example, an instrument name (a system name), a model name, an OS (Operating System) version, a management password, a privilege password, a communication instrument IP (Internet Protocol) address (a management IP), and the like, as shown in FIG. 5.

Also, the instrument setting information 12, being information for configuring a static configuration of each communication instrument, and initialization information necessary for a dynamic configuration, is configured of, for example, definition information relating to an IP (an IP definition), definition information relating to a port (a port definition), definition information relating to a VLAN (Virtual LAN) (a VLAN definition), definition information relating to an STP (Spanning Tree Protocol) (an STP definition), definition information relating to an SNMP (Simple Network Management Protocol) (an SNMP definition), and the like, as shown in FIG. 5.

Such setting information 10 is held, for example, in a list format in which setting values included in the individual items of setting information are listed in order from the top, as in “detailed setting information” shown in FIG. 5.

Meanwhile, the physical connection information 20, being information indicating a physical connection between the communication instruments, specifically, is configured of setting information indicating a port configuration diagram 21, as shown in FIG. 6. The port configuration diagram 21 is information for identifying a port used for the connection between the communication instruments. The physical connection information is configured by correlating, for example, an instrument name, slot and port of a connection origin to an instrument name, slot and port of a connection destination, as shown in FIG. 6.

Such physical connection information 20 is held, for example, in a list format in which setting values included in the setting information indicating the port configuration diagram 21 are listed in order from the top, as in “physical connection data” shown in FIG. 6.

Returning to FIG. 4, the dynamic configuration calculation logic memory 112 is a memory which stores dynamic configuration calculation logic information which defines a logic for generating, on the layer-by-layer basis, dynamic configuration information dynamically fixed after the network construction, for elements, such as the STP (Spanning Tree Protocol) and a VRRP (Virtual Router Redundancy Protocol), of which a condition is determined after each communication instrument operates.

The dynamic configuration calculator 113 is a processor which generates the instrument setting information 31, on the layer-by-layer basis, based on the design information 10 and physical connection information 20 read by the design information reader 111, and the dynamic configuration calculation logic information stored in the dynamic configuration calculation logic memory 112. The dynamic configuration calculator 113 generates the dynamic configuration information, on the layer-by-layer basis, based on the design information 10 and the physical connection information 20, as well as the dynamic configuration calculation logic information. Then, the dynamic configuration calculator 113 generates the instrument setting information 31 by adding the generated dynamic configuration information to the instrument setting information included in the design information 10, and transmits the generated instrument setting information 31 to the topology comparator 130.

The logical connection calculator 114 is a processor which generates the physical/logical connection information 32, on the layer-by-layer basis, based on the instrument setting information 31 generated by the dynamic configuration calculator 113, and the physical connection information 20 retrieved by the design information reader 111. The logical connection calculator 114 acquires the instrument setting information 31 and the physical connection information 20, generates the topology information, on the layer-by-layer basis, using the well-known data generation method described first in the embodiment, and transmits all the generated items of topology information as the physical/logical connection information 32 to the topology comparator 130.

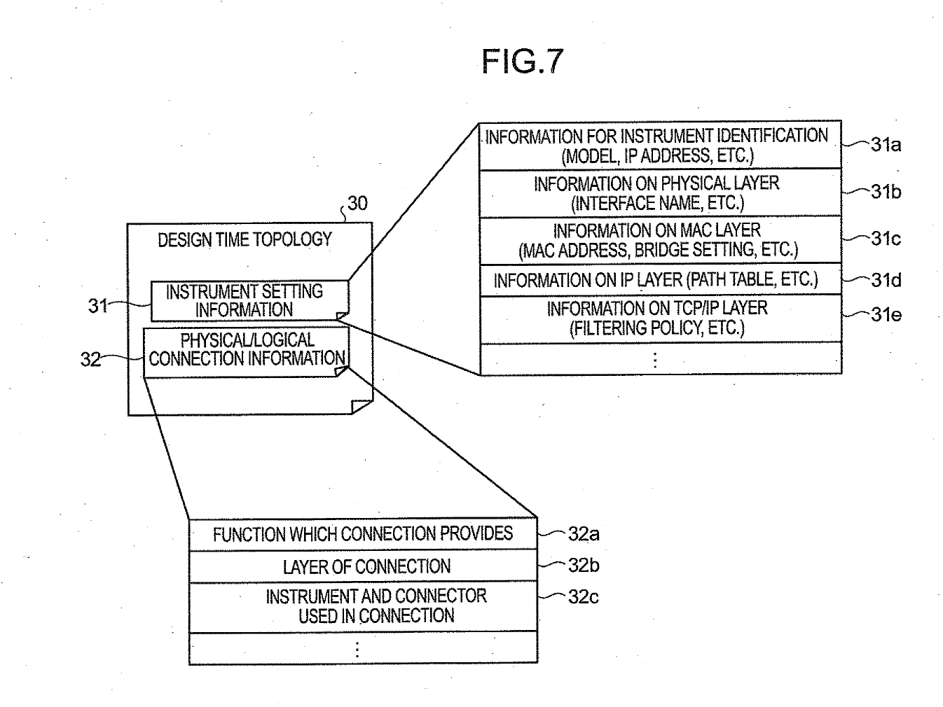

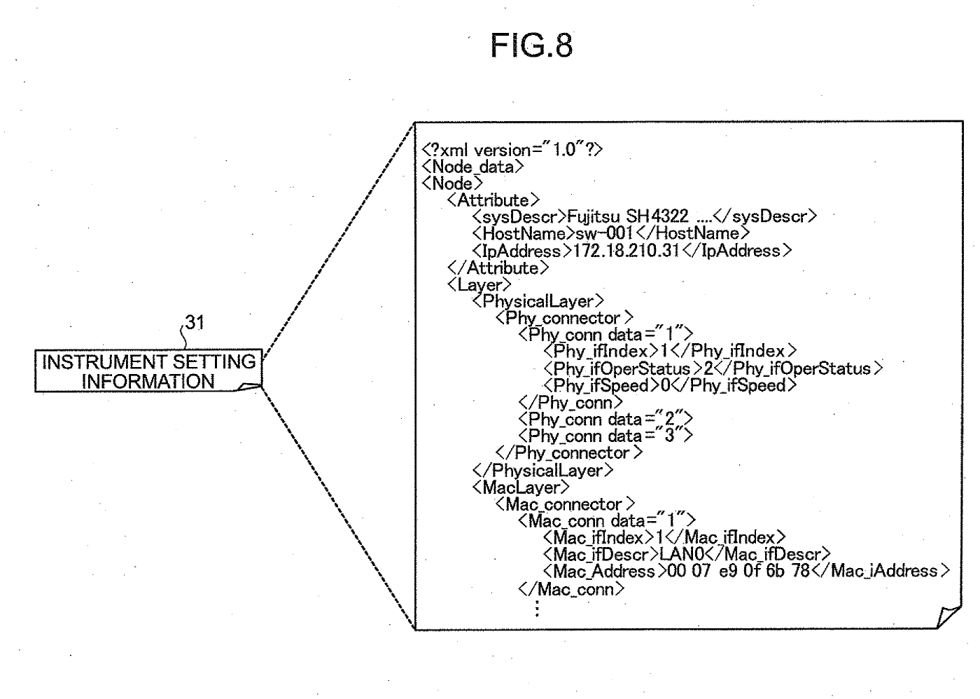

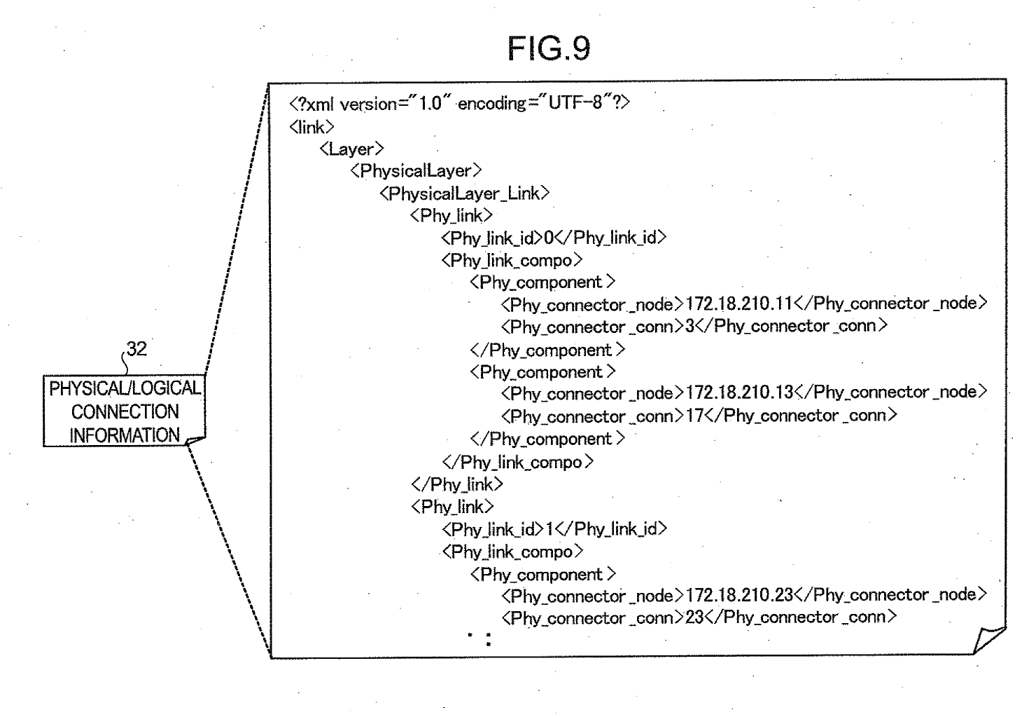

In the embodiment, both the heretofore described instrument setting information 31 and physical/logical connection information 32 are taken to be the design time topology 30. FIG. 7 is a diagram for illustrating the design time topology 30, FIG. 8 is a diagram showing an example of the instrument setting information 31, and FIG. 9 is a diagram showing an example of the physical/logical connection information 32. As shown in FIG. 7, the instrument setting information 31 and the physical/logical connection information 32 are included in the design time topology 30.

Of these, the instrument setting information 31, being information indicating layer-by-layer static configuration information and dynamic configuration information of each communication instrument, is configured of instrument identification information (a model, an IP address, etc.) 31a, physical layer information (an interface name, etc.) 31b, MAC layer information (a MAC address, a bridge setting, etc.) 31c, IP layer information (a path table, etc.) 31d, TCP/IP layer information (a filtering policy, etc.) 31e, and the like, as shown in FIG. 7.

Such instrument setting information 31 is held, for example, as shown in FIG. 8, in a list format in which attribute information included in the instrument identification information (refer to <Attribute> to </Attribute> shown in FIG. 8), and each setting value included in the layer-by-layer information (refer to <PhysicalLayer> to </PhysicalLayer>, <MacLayer> and so on shown in FIG. 8) are listed in order from the top.

Meanwhile, the physical/logical connection information 32, being information indicating the layer-by-layer physical connection or logical connection (link) of each communication instrument, as shown in FIG. 8, is configured of a function 32a provided by the connection, a layer 32b of the connection, a communication instrument and a connector 32c which are used for the connection, and the like.

Such physical/logical connection information 32 is held, for example, as shown in FIG. 9, in a list format in which the physical connection information and the logical connection information are listed in order, from the top, on the layer-by-layer basis. For example, FIG. 9, showing the physical connection information of the physical layer (refer to <PhysicalLayer> and so on shown in FIG. 9), shows that a certain physical connection (refer to first <Phy_link> to </Phy_link> shown in FIG. 9), of which a connection ID is “0” (refer to first <Phy_linkid> to </Phy_link_id> shown in FIG. 9), connects a connector “3” of a communication instrument of which the IP address is “172.18.210.11” (refer to first <Phy_connector_node> to </Phy_connector_node> and <Phy_connector_conn> to </Phy_connector_conn> shown in FIG. 9) and a connector “17” of a communication instrument of which the IP address is “172.18.210.13” (refer to second <Phy_connector_node> to </Phy_connector_node> and <Phy connector_conn> to </Phy_connector_conn> shown in FIG. 9).

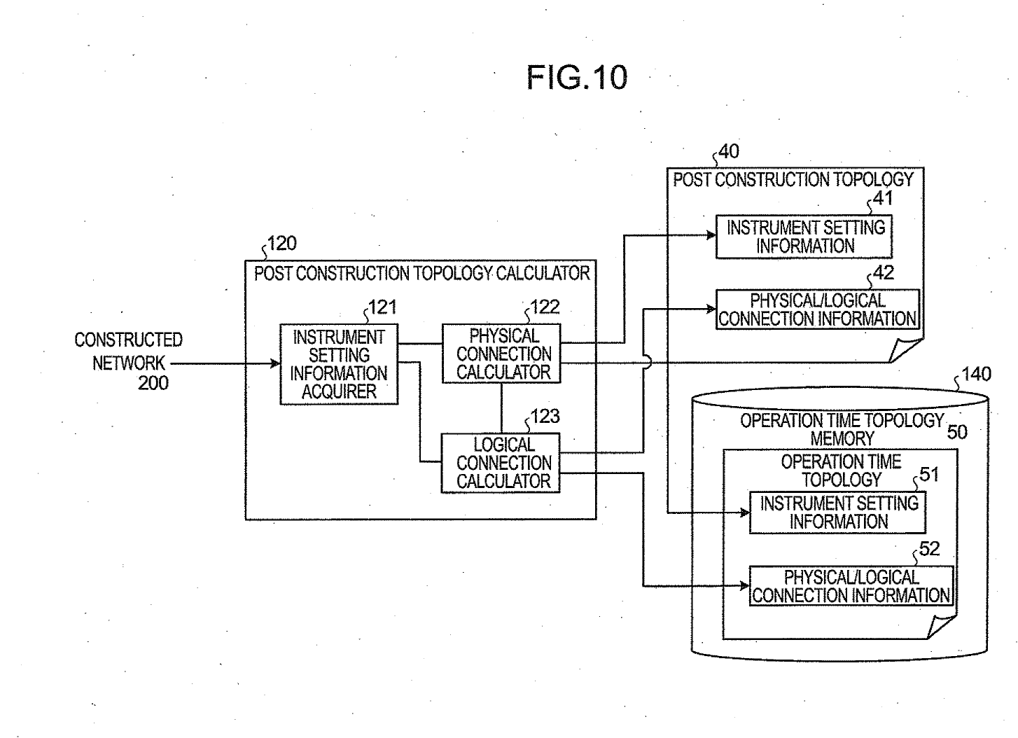

Next, a description will be given of a configuration of the post construction topology calculator 120 shown in FIG. 3. FIG. 10 is a functional block diagram showing the configuration of the post construction topology calculator 120. As shown in FIG. 10, the post construction topology calculator 120, being connected to the constructed network 200 and the operation time topology memory 140, has an instrument setting information acquirer 121, a physical connection calculator 122 and a logical connection calculator 123.

The instrument setting information acquirer 121 is a processor which collects the layer-by-layer instrument setting information and physical connection information from each communication instrument connected to the constructed network 200. The instrument setting information acquirer 121 collects the layer-by-layer instrument setting information and physical connection information from the communication instruments connected to the constructed network 200 in a predetermined cycle, not only during a verification at a network construction time, but also after the network operation is started.

The physical connection calculator 122 is a processor which generates instrument setting information 41, and physical connection information indicating a connection configuration of the physical layer, based on the instrument setting information and physical connection information collected by the instrument setting information acquirer 121. The instrument setting information 41 generated herein is generated in the same format as that of the instrument setting information 31 shown in FIG. 8. Then, upon generating the instrument setting information 41, the physical connection calculator 122 transmits the generated instrument setting information 41 to the topology comparator 130.

The physical connection information generated herein includes the dynamic configuration information dynamically fixed after the network construction, for the elements, such as the STP and the VRRP, of which the condition is determined after each communication instrument operates. By this means, when comparing the instrument setting information 31 transmitted from the heretofore described dynamic configuration calculator 113, and the instrument setting information 41 transmitted from the physical connection calculator 122, it is possible for the topology comparator 130, to be described hereafter, to compare the items of instrument setting information, including the dynamic configuration information too.

The physical connection calculator 122 generates instrument setting information 51, and the physical connection information indicating the connection configuration of the physical layer, on a time-point by time-point basis, based on the instrument setting information and physical connection information collected in the predetermined cycle by the instrument setting information acquirer 121. Then, the physical connection calculator 122 stores the instrument setting information 51 generated on the time-point by time-point basis in the operation time topology memory 140.

The logical connection calculator 123 is a processor which generates physical/logical connection information 42 based on the instrument setting information and physical connection information collected by the instrument setting information acquirer 121, and the physical connection information generated by the physical connection calculator 122. The logical connection calculator 123, using the well-known data generation method described at the outset of the embodiment, generates the physical/logical connection information 42 which is layer-by-layer topology information, and transmits the generated physical/logical connection information 42 to the topology comparator 130.

The logical connection calculator 123, after the network operation is started, generates physical/logical connection information 52, which is based on the instrument setting information and physical connection information collected in the predetermined cycle by the instrument setting information acquirer 121, and on the time-point by time-point physical connection information generated by the physical connection calculator 122, on the time-point by time-point basis. Then, the physical connection calculator 122 stores the physical/logical connection information 52 generated on the time-point by time-point basis in the operation time topology memory 140.

Both the heretofore described instrument setting information 41 and physical/logical connection information 42 are taken to be the post construction topology 40, and both the instrument setting information 51 and the physical/logical connection information 52 are taken to be the operation time topology 50. The instrument setting information 41 and the physical/logical connection information 42, and the instrument setting information 51 and the physical/logical connection information 52, are each configured in the same formats as those of the instrument setting information 31 shown in FIG. 8 and the physical/logical connection information 32 shown in FIG. 9.

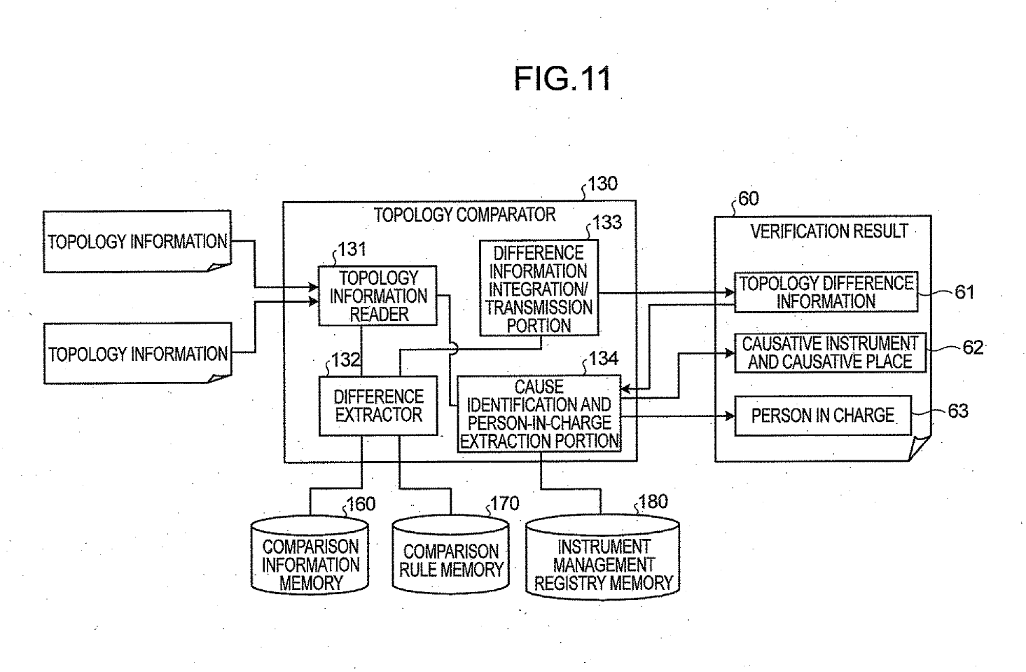

Next, a description will be given of a configuration of the topology comparator 130 shown in FIG. 3. FIG. 11 is a functional block diagram showing the configuration of the topology comparator 130. As shown in FIG. 11, the topology comparator 130, being connected to a comparison information memory 160, a comparison rule memory 170 and an instrument management registry memory 180, has a topology information reader 131, a difference extractor 132, a difference information integration/transmission portion 133, and a cause identification and person-in-charge extraction portion 134.

The comparison information memory 160 is a memory which stores comparison information, which correlates a comparison item, information indicating an existence or otherwise of a comparison, and information indicating a determination method, for every item of setting information included in each item of topology information. The comparison rule memory 170 is a memory which stores the information indicating the determination method, and comparison rule information defining a determination logic, for every determination method when comparing the setting information. The instrument management registry memory 180 is a memory which stores instrument management information, which correlates instrument identification information identifying a communication instrument, and person-in-charge information identifying a person in charge of managing a communication instrument, for every communication instrument.

The topology information reader 131 is a processor which reads two items of topology information. The topology information reader 131, in the verification at the network construction time, reads the design time topology 30 and the post construction topology 40 and, after the network operation is started, referring to the operation time topology memory 140 in a predetermined cycle, reads an operation time topology 50 stored last, and an operation time topology 50 stored the time before last.

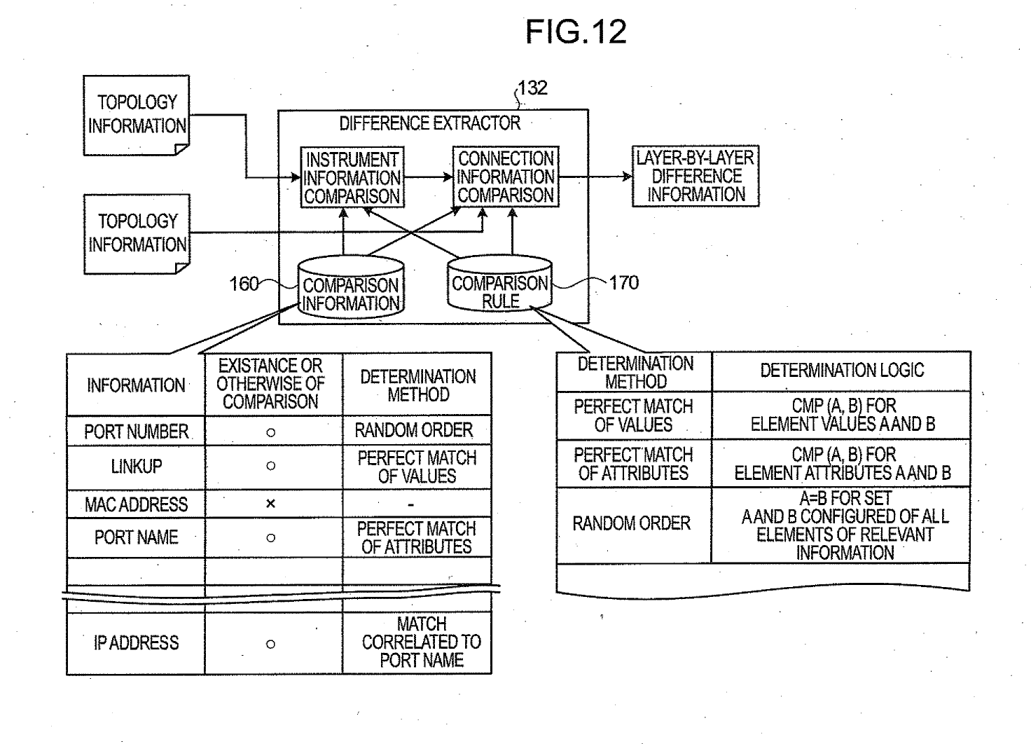

The difference extractor 132 is a processor which compares the instrument setting information and the physical/logical connection information, included in the two items of topology information read by the topology information reader 131, on the layer-by-layer basis. FIG. 12 is a diagram for illustrating a difference extraction process carried out by the difference extractor 132. Specifically, the difference extractor 132, as shown in FIG. 12, based on the comparison information stored in the comparison information memory 160 and the comparison rule information stored in the comparison rule memory 170, compares the instrument setting information and the physical/logical connection information, included in the two items of topology information, on the layer-by-layer basis. Then, the difference extractor 132, based on the instrument setting information and the physical/logical connection information between which a difference (the mismatch) has occurred as a comparison result, generates difference information on the layer-by-layer basis.

The difference information integration/transmission portion 133 is a processor which generates topology difference information 61 based on the layer-by-layer difference information transmitted by the difference extractor 132. Specifically, the difference information integration/transmission portion 133 inputs each item of layer-by-layer difference information generated by the difference extractor 132 and, by integrating the input difference information, generates the topology difference information 61.

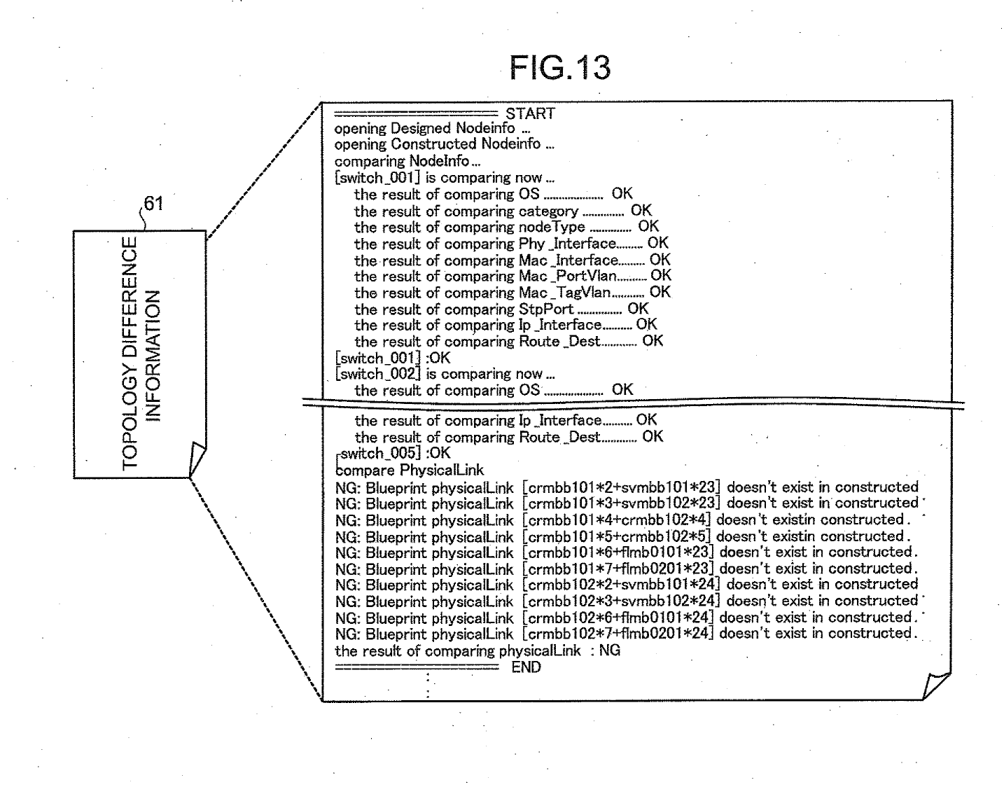

FIG. 13 is a diagram showing an example of the topology difference information 61. The difference information integration/transmission portion 133 generates the topology difference information 61, for example, in a list format in which results (“OK” or “NG”, and the like) of comparing the instrument setting information and the physical/logical connection information on the layer-by-layer basis are listed in order from the top, as shown in FIG. 13.

Then, the difference information integration/transmission portion 133, upon generating the topology difference information 61, transmits the generated topology difference information 61 to, for example, a display device such as a display, an output device such as a printer, and the like.

The cause identification and person-in-charge extraction portion 134 is a processor which, based on the topology difference information 61 generated by the difference information integration/transmission portion 133, and the design time topology 30, identifies a causative communication instrument and place, in which the difference in the topology information has occurred, and a person in charge of the causative communication instrument.

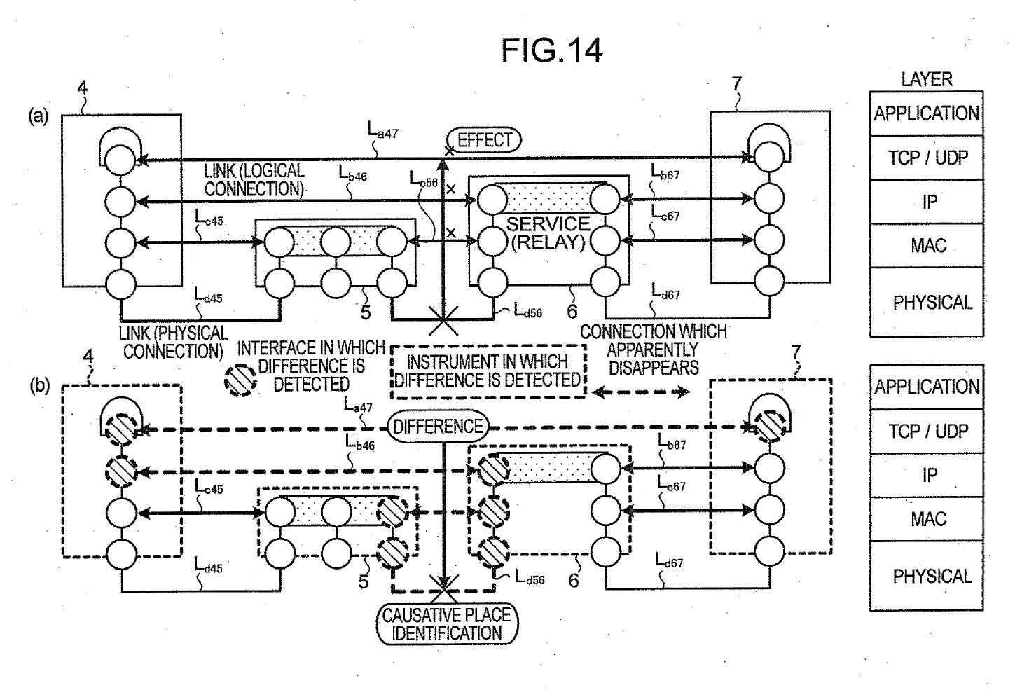

First, a description will be given of a principle of identifying the causative place by means of the cause identification and person-in-charge extraction portion 134. FIGS. 14A and 14B are diagrams for illustrating the principle of identifying the causative place by means of the cause identification and person-in-charge extraction portion 134. For example, as shown in FIG. 14A, it is taken that the communication instruments 4, 5, 6 and 7 are connected to the network

Herein, in the TCP/UDP layer, it is taken that the communication instrument 4 and the communication instrument 7 are logically connected by a link La47. Also, in the IP layer, it is taken that the communication instrument 4 and the communication instrument 6 are logically connected by a link Lb46. Furthermore, it is taken that the communication instrument 6 and the communication instrument 7 are logically connected by a link Lb67. In addition, in the MAC layer, it is taken that the communication instrument 4 and the communication instrument 5 are logically connected by a link Lc45. Also, it is taken that the communication instrument 5 and the communication instrument 6 are logically connected by a link Lc56. Furthermore, it is taken that the communication instrument 6 and the communication instrument 7 are logically connected by a link Lc67. In addition, in the physical layer, it is taken that the communication instrument 4 and the communication instrument 5 are physically connected by a link Ld45. Also, it is taken that the communication instrument 5 and the communication instrument 6 are physically connected by a link Ld56, and that the communication instrument 6 and the communication instrument 7 are physically connected by a link Ld67.

Then, as a result of the network configuration verification apparatus carrying out a verification for the heretofore described network, as shown in FIG. 14B, it is taken that the topology information has a difference, which occurs in the link La47 of the TCP/UDP layer, included in the transmitted topology difference information 61.

In this case, the cause identification and person-in-charge extraction portion 134, first, acquires logical connection information of the link La47 included in the topology difference information 61, and acquires communication instrument and connector information included in the acquired logical connection information. Subsequently, the cause identification and person-in-charge extraction portion 134, based on the acquired information, searches the physical/logical connection information 32 of the design time topology 30, and acquires, from among the logical connection information of the IP layer which is a lower layer below the link La47, logical connection information of a link (a link represented as a subset of the link La47 when expressed as the model shown in FIGS. 1 and 2) which acts as a connection configuration element of the link La47. In this example, the cause identification and person-in-charge extraction portion 134 acquires the logical connection information of the link Lb46 and the logical connection information of the link Lb67.

Subsequently, the cause identification and person-in-charge extraction portion 134 confirms whether or not each acquired item of logical connection information is included in the topology difference information 61. Herein, it is taken that the logical connection information of the link Lb46 is included in the topology difference information 61.

In this case, the cause identification and person-in-charge extraction portion 134, based on the logical connection information of the link Lb46, searches the physical/logical connection information 32 of the design time topology 30, and acquires, from among the logical connection information of the MAC layer which is a lower layer below the link Lb46, logical connection information of a link (a link represented as a subset of the link Lb46 when expressed as the model shown in FIGS. 1 and 2) which acts as a connection configuration element of the link Lb46. In this example, the cause identification and person-in-charge extraction portion 134 acquires the logical connection information of the link Lc45, the logical connection information of the link Lc56, and the logical connection information of the link Lc67.

Subsequently, the cause identification and person-in-charge extraction portion 134 confirms whether or not each acquired item of logical connection information is included in the topology difference information 61. Herein, it is taken that the logical connection information of the link Lc56 is included in the topology difference information 61.

In this case, the cause identification and person-in-charge extraction portion 134, based on the logical connection information of the link Lc56, searches the physical/logical connection information 32 of the design time topology 30. Then, the cause identification and person-in-charge extraction portion 134 acquires, from among the logical connection information of the physical layer which is a lower layer below the link Lc56, logical connection information of a link (a link represented as a subset of the link Lc56 when expressed as the model shown in FIGS. 1 and 2) which acts as a connection configuration element of the link Ld56. In this example, the cause identification and person-in-charge extraction portion 134 acquires the logical connection information of the link Ld56.

Herein, the cause identification and person-in-charge extraction portion 134, as it has confirmed the acquisition of the logical connection information of the physical layer, determines that a lowermost layer has been reached, and identifies the link Ld56 as the place which has caused the occurrence of the difference in the link La47 (the causative place).

The cause identification and person-in-charge extraction portion 134, when it searches the physical/logical connection information 32 of the design time topology 30 for a link of a certain layer, in the event that logical connection information of a link which acts as the connection configuration element is not found in the logical connection information of a lower layer below the relevant link, identifies a link which has last acquired the logical connection information as the causative place. The cause identification and person-in-charge extraction portion 134, when it similarly confirms whether or not the logical connection information acquired from the physical/logical connection information 32 of the design time topology 30 is included in the topology difference information 61, even in the event that the relevant logical connection information is not included therein, identifies the link which has last acquired the logical connection information as the causative place.

Then, after identifying the link acting as the causative place, the cause identification and person-in-charge extraction portion 134 extracts instrument identification information (the IP address, etc.) which identifies a communication instrument connected by the identified link from the logical connection information of the relevant link and, based on the extracted instrument identification information, identifies a communication instrument which has caused the occurrence of the difference (a causative instrument). In this example, the cause identification and person-in-charge extraction portion 134 identifies the communication instruments 5 and 6 as the causative instruments.

In this way, the cause identification and person-in-charge extraction portion 134, in the event that the difference has occurred in the topology information in a certain layer, sequentially confirms whether or not the difference has occurred in the topology information in lower layers below the relevant layer. By so doing, it is possible for the network manager to identify the mismatch in the lower layer which causes the mismatch detected in an upper layer.

Then, the cause identification and person-in-charge extraction portion 134, furthermore, based on the instrument identification information of the communication instrument identified as the causative instrument, searches the instrument management information stored in the instrument management registry memory 180, and identifies a person in charge of managing the relevant communication instrument.

In this way, the cause identification and person-in-charge extraction portion 134 identifies the causative place, the causative instrument, and the person in charge of the causative instrument, for all items of difference information included in the topology difference information 61, and transmits all the identified causative places and causative instruments as causative instruments and causative places 62 to, for example, the display device such as the display, the output device such as the printer, and the like.

In the same way, all the identified causative persons in charge are transmitted as persons in charge 63 to, for example, the display device such as the display, the output device such as the printer, and the like.

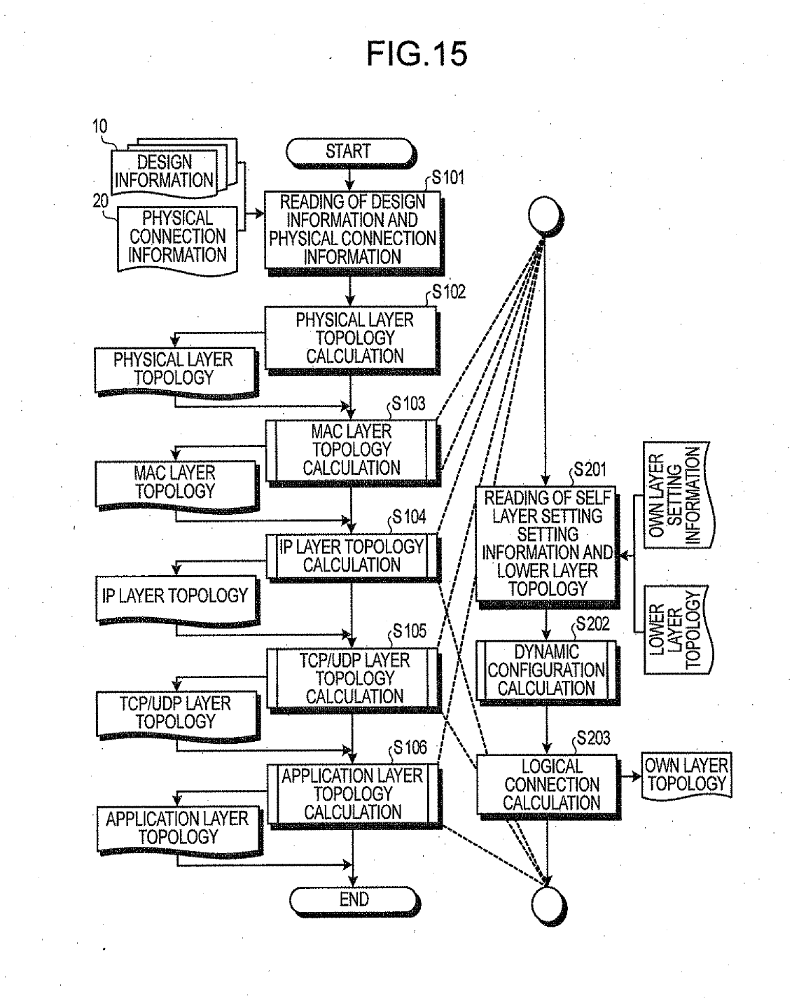

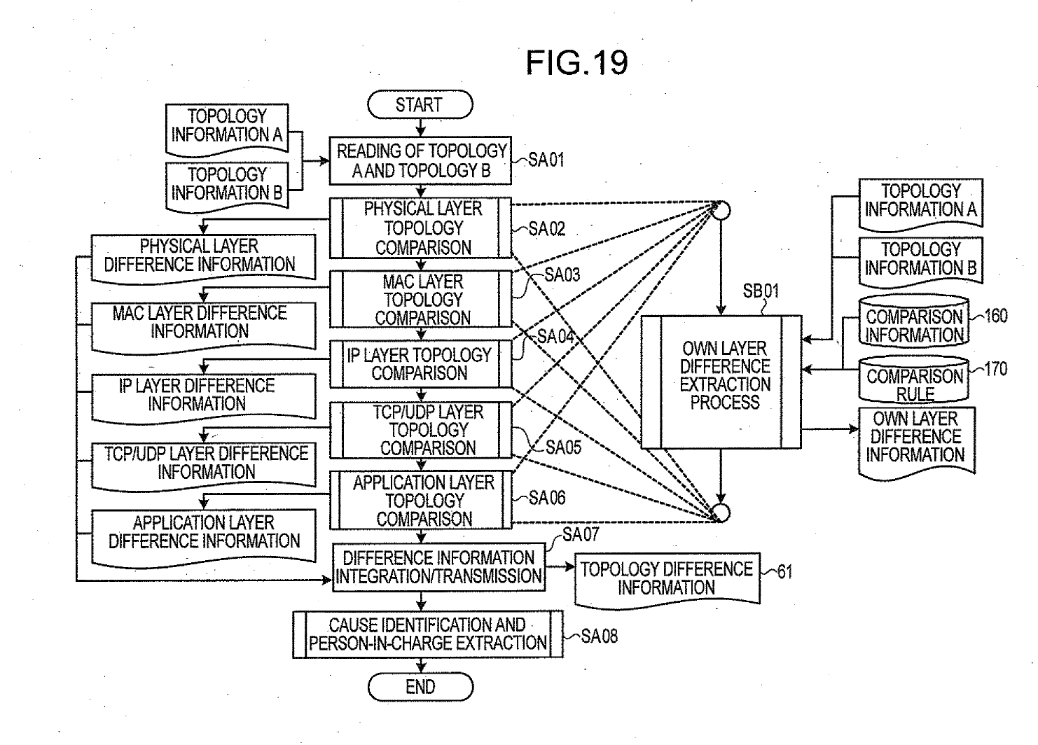

Next, a description will be given of processing procedures of the design time topology calculator 110 and the topology comparator 130. Hereafter, after the processing procedure of the design time topology calculator 110 is described using FIGS. 15 to 18, the processing procedure of the topology comparator 130 will be described using FIGS. 19, 20 and 21.

First, a description will be given of the processing procedure of the design time topology calculator 110. FIG. 15 is a flowchart showing the processing procedure of the design time topology calculator 110. As shown in FIG. 15, in the design time topology calculator 110, first, the design information reader 111 reads the design information 10 and the physical connection information 20 (operation S101).

Subsequently the logical connection calculator 114 obtains an activity of a physical port of each communication instrument from the design information 10 and the physical connection information 20, and transmits a connection list, and a port condition of each communication instrument, as the topology information of the physical layer (operation S102).

Then, the logical connection calculator 114 obtains a post network-construction logical connection of the MAC layer from the topology information of the physical layer and the communication instrument design information 10 of the MAC layer, and transmits it as the topology information of the MAC layer (operation S103).

Hereafter, the dynamic configuration calculator 113 and the logical connection calculator 114 repeat the same operation while moving up from one layer to another, obtain post network-construction conditions of all the layers, and transmit them as the topology information of each layer (operations S104 to S106).

Herein, a detailed description will be given of a calculation procedure of a dynamic configuration of the MAC layer or upper layers in operations S103 to S106. First, the design information reader 111 reads the topology information in a lower layer, and the instrument setting information of its own layer (operation S201).

Subsequently, the dynamic configuration calculator 113 obtains connectors, from among connectors which provide a communication instrument dynamic configuration of the own layer, neighboring each other via the logical connection of the lower layer, and generates an activity of the connectors, and logical connection information of the connectors, as a dynamically determined configuration (operation S202). Then, the logical connection calculator 114 generates logical connection information statically determined by an instrument setting, and transmits both items of logical connection information as topologies of the own layer (operation S203).

Herein, in the embodiment, as an example of the heretofore described dynamic configuration calculation carried out by the dynamic configuration calculator 113, a description will be given of an STP dynamic configuration calculation, a VTP (VLAN Trunk Protocol) dynamic configuration calculation, and an HSRP (Hot Standby Router Protocol) dynamic configuration calculation. These processes are included in a MAC layer topology calculation shown in FIG. 15.

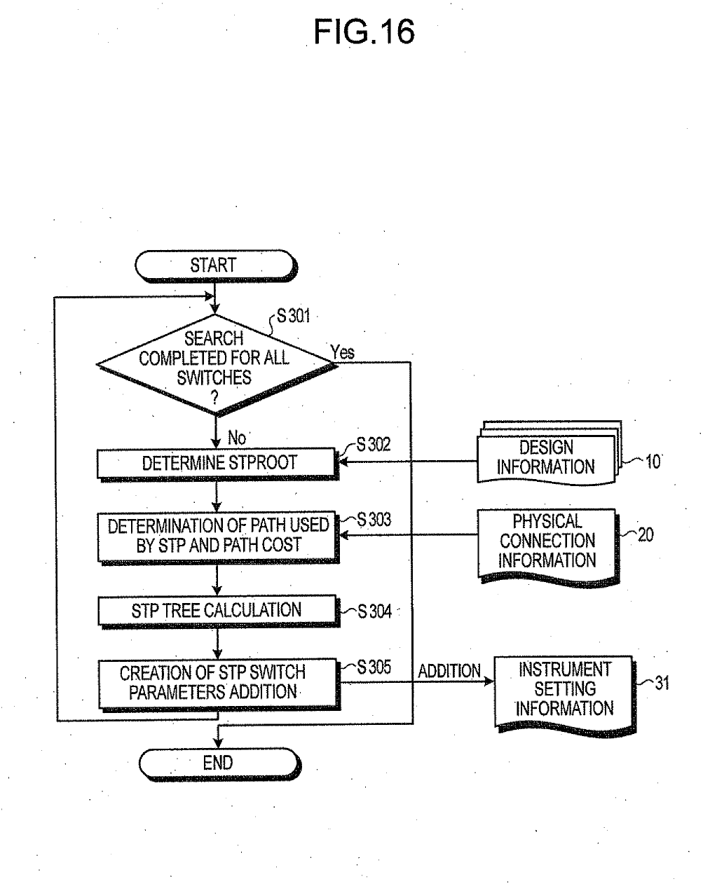

First, a description will be given of a processing procedure of the STP dynamic configuration calculation. FIG. 16 is a flowchart showing the processing procedure of the STP dynamic configuration calculation. As shown in FIG. 16, in the STP dynamic configuration calculation, first, the dynamic configuration calculator 113 confirms whether or not a search is completed for all switches and, if the search is completed (operation S301, Yes), finishes the STP dynamic configuration calculation.

Contrarily, if the search is not completed (operation S301, No), the dynamic configuration calculator 113 searches the design information 10 for a switch acting as an STPRoot, from among switches in a search range. At this time, the dynamic configuration calculator 113, using an STPPriority value, finds the switches, and takes a switch with a smallest value to be the STPRoot (operation S302).

Subsequently, the dynamic configuration calculator 113 examines what information is necessary for an STP tree calculation. First, the dynamic configuration calculator 113, based on the physical connection information 20, sets a communication instrument and a path cost at either end of each connection at which a port is active. At this time, the dynamic configuration calculator 113, as shown in the following table, determines the path cost in accordance with a link speed (operation S303).

The dynamic configuration calculator 113 sets the path costs for all extracted links and, from the connections and the path costs, obtains a path (Spanning-Tree) from each switch to the STPRoot, using, for example, a dijkstra method (operation S304). Then, the dynamic configuration calculator 113 derives STP related parameters, including each port condition (Forwarding or Blocking), from the obtained paths, and adds them to the instrument setting information 31 (operation S305).

Then, the dynamic configuration calculator 113 returns to operation S301, and repeats the heretofore described processes until it finishes finding all the switches.

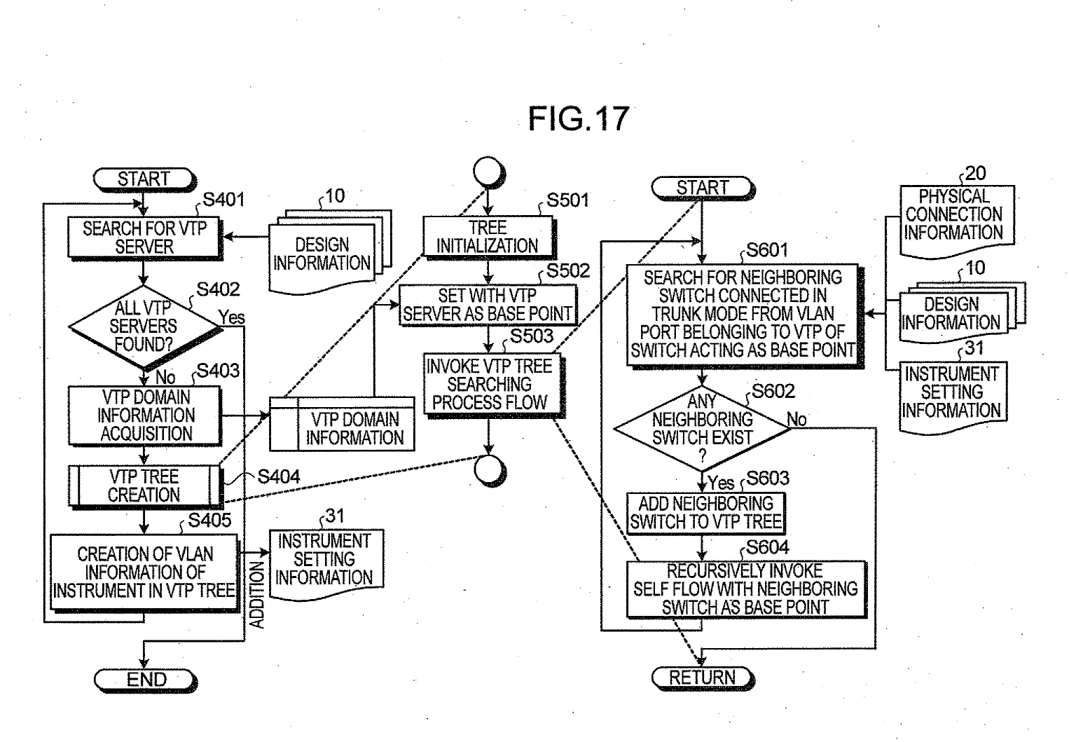

Subsequently, a description will be given of a processing procedure of the VTP dynamic configuration calculation. FIG. 17 is a flowchart showing the processing procedure of the VTP dynamic configuration calculation. As shown in FIG. 17, in the VTP dynamic configuration calculation, first, the dynamic configuration calculator 113 searches the design information 10 for communication instruments set as VTP servers (operation S401). Herein, the dynamic configuration calculator 113, if it has already found all the VTP servers (operation S402, Yes), finishes the VTP dynamic configuration calculation.

Contrarily, if there is any unfound VTP server (operation S402, No), the dynamic configuration calculator 113 acquires VTP domain information of the relevant VTP server instrument, used to transmit the VTP, from the design information 10, and stores it in an internal memory (operation S403).

Subsequently, the dynamic configuration calculator 113 creates a VTP tree, indicating a range in which the VTP protocol is transmitted, from the VTP domain information, the physical connection information 20, the design information 10 and the instrument setting information 31 (operation S404), extracts VLAN names and the like of the switches included in the VTP tree from the VTP domain information, and adds them to the instrument setting information 31 (operation S405).

Herein, a detailed description will be given of the VTP tree creation of operation S404. First, the dynamic configuration calculator 113 initializes the VTP tree indicating the range in which the VTP protocol is transmitted (operation S501). Subsequently, the dynamic configuration calculator 113 sets the VTP server as a base point for searching the VTP tree (operation S502), and invokes a VTP tree searching process flow (operation S503).

The VTP tree searching process flow, being a process of recursively constructing the tree, is carried out according to the following procedure. First, the dynamic configuration calculator 113, regarding a switch acting as the base point, referring to the design information 10, the physical connection information 20, and the instrument setting information 31 including the dynamic configuration information relating to the previously mentioned STP, searches for a switch neighboring a port of the relevant switch (operation $601).

At this time, the port to be searched for needs to fulfill three conditions:
a. It is a port configuring a VLAN belonging to a VTP domain being searched,
b. A setting of the port is of a “trunk mode” which transmits the VTP, and
c. The port is active, and is not blocked by the STP.

Herein, if no neighboring switch can be found (operation S602, No), the dynamic configuration calculator 113 finishes the VTP tree searching process flow, and returns the process to the flow invoker. Contrarily, if a neighboring switch can be found, the dynamic configuration calculator 113 adds the neighboring switch found to the VTP tree (operation S603).

Then, the dynamic configuration calculator 113 recursively invokes the VTP tree searching process flow with the relevant neighboring switch as the search base point (operation S604), returns to operation S601 in order to search for another switch neighboring the switch acting as the search base point, and repeats the heretofore described processes.

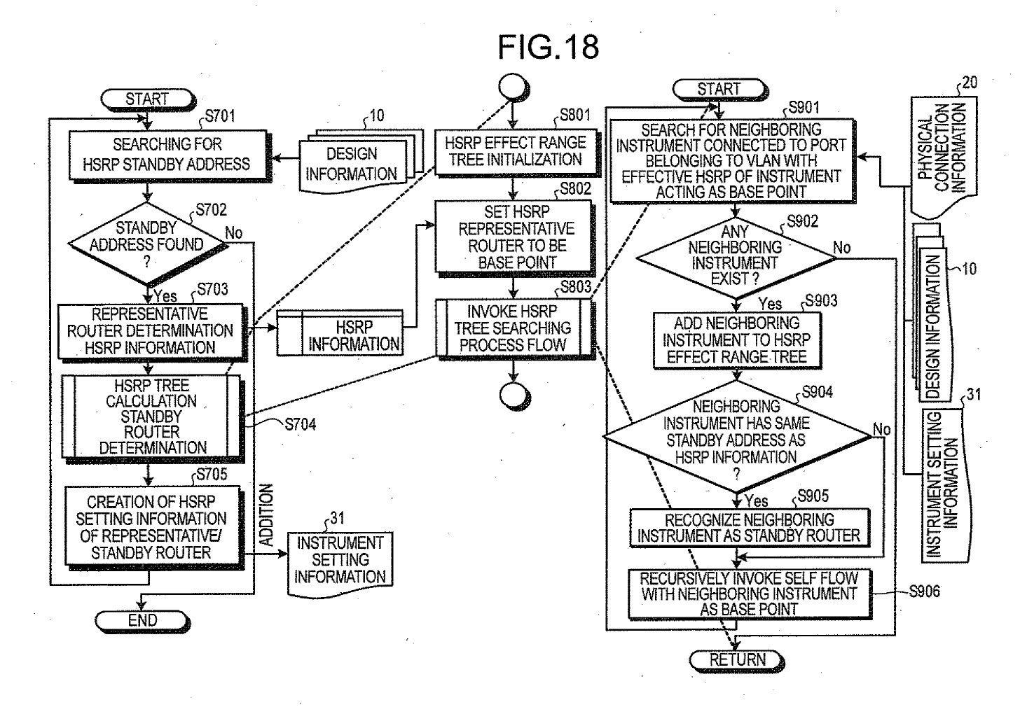

Subsequently, a description will be given of a processing procedure of the HSRP dynamic configuration calculation. FIG. 18 is a flowchart showing the processing procedure of the HSRP dynamic configuration calculation. As shown in FIG. 18, in the HSRP dynamic configuration calculation, first, the dynamic configuration calculator 113 extracts a communication instrument having a standby address of the HSRP from a setting of the HSRP of each node included in the design information 10 (operation S701). Herein, the dynamic configuration calculator 113, if a search has already been completed for all the standby addresses (operation S702, No), finishes the HSRP dynamic configuration calculation.

Contrarily, if there is any communication instrument having an unfound standby address (operation S702, Yes), the dynamic configuration calculator 113 determines a representative router of the relevant standby address from the design information of the relevant communication instrument, acquires information relating to the HSRP setting, and stores it in the internal memory (operation S703).

Subsequently, the dynamic configuration calculator 113 creates an HSRP tree, indicating a range in which the HSRP protocol is transmitted, from the HSRP information, the physical connection information 20, the design information 10 and the instrument setting information 31, and takes an HSRP instrument inside the tree to be a standby router (operation S704).

Then, the dynamic configuration calculator 113 extracts various kinds of setting information of the representative router and the standby router from the HSRP information, and adds them to the instrument setting information 31 (operation S705).

Herein, a detailed description will be given of the standby router determination of operation S704. First, the dynamic configuration calculator 113 initializes the HSRP tree indicating the range in which the HSRP protocol is transmitted (operation S801). Subsequently, the dynamic configuration calculator 113 sets the representative router as a base point for searching the HSRP tree (operation S802), and invokes an HSRP tree searching process flow (operation S803).

The HSRP tree searching process flow, being a process which recursively constructs the tree, is carried out according to the following procedure. First, the dynamic configuration calculator 113, regarding a router acting as the base point, referring to the design information 10, the physical connection information 20, and the instrument setting information 31 including the dynamic configuration information relating to the previously mentioned STP and VTP, searches for a communication instrument neighboring a port of the relevant router (operation S901).

At this time, the port to be searched for needs to fulfill two conditions:
a. It is a port in which is set an HSRP representative address being searched for, or a port which belongs to the VLAN in which is set the standby address, and configures the VLAN, and
b. The port is active, and is not blocked by the STP.

Herein, if no neighboring communication instrument can be found (operation S902, No), the dynamic configuration calculator 113 finishes the HSRP searching process flow, and returns the process to the flow invoker. Contrarily, if a neighboring communication instrument can be found, the dynamic configuration calculator 113 adds the communication instrument found to the HSRP tree (operation S903).

Then, the dynamic configuration calculator 113 determines whether or not the communication instrument found is an instrument which interprets the HSRP, and has the standby address of the HSRP tree being searched. If the relevant communication instrument has the standby address (operation S904, Yes), the dynamic configuration calculator 113 recognizes the communication instrument as the standby router (operation S905).

Subsequently, the dynamic configuration calculator 113 recursively invokes the HSRP searching process flow with the relevant neighboring instrument as the search base point (operation S906), returns to operation S901 when the process of the invoked flow finishes, in order to search for another instrument neighboring the communication instrument acting as the search base point, and repeats the heretofore described processes.

As above, the processing procedure of the design time topology calculator 110 has been described. In this way, in a case in which the network has actually been constructed, the design time topology calculator 110, based on the design information 10 and the physical connection information 20, generates the design time topology 30 (the instrument setting information 31 and the physical/logical connection information 32) on the layer-by-layer basis.

Also, the design time topology calculator 110, when generating the instrument setting information 31, also predicts and generates setting information, which is dynamically set in each communication instrument after the network construction, based on the design time information (the design information 10 and the physical connection information 20).

Subsequently a description will be given of a processing procedure of the topology comparator 130. FIG. 19 is a flowchart showing the processing procedure of the topology comparator 130. As shown in FIG. 19, in the topology comparator 130, first, the topology information reader 131 reads at least two items of topology information (operation SA01). Herein, the items of topology information are referred to as topology information A and topology information B.

Subsequently, the difference extractor 132, based on the comparison information stored in the comparison information memory 160 and the comparison rule information stored in the comparison rule memory 170, compares topology information of the physical layer, the topology information A and the topology information B, and generates a difference between them as difference information of the physical layer (operation SA02).

Hereafter, the difference extractor 132 repeats the same operation while moving up from one layer to another and, based on the comparison information stored in the comparison information memory 160 and the comparison rule information stored in the comparison rule memory 170, generates the difference information of all the layers (operations SA03 to SA06). The processes of operations SA02 to SA06 are referred to as an own layer difference extraction process (operation SB01).

After the difference information of all the layers is generated by the difference extractor 132, the difference information integration/transmission portion 133 integrates the difference information of all the layers, and transmits the integrated difference information as the topology difference information 61 (operation SA07). Furthermore, the cause identification and person-in-charge extraction portion 134, based on the topology difference information 61, identifies a causative place from which a plurality of differences derive, and identifies and transmits a communication instrument having the causative place and a person in charge thereof (operation SA08).

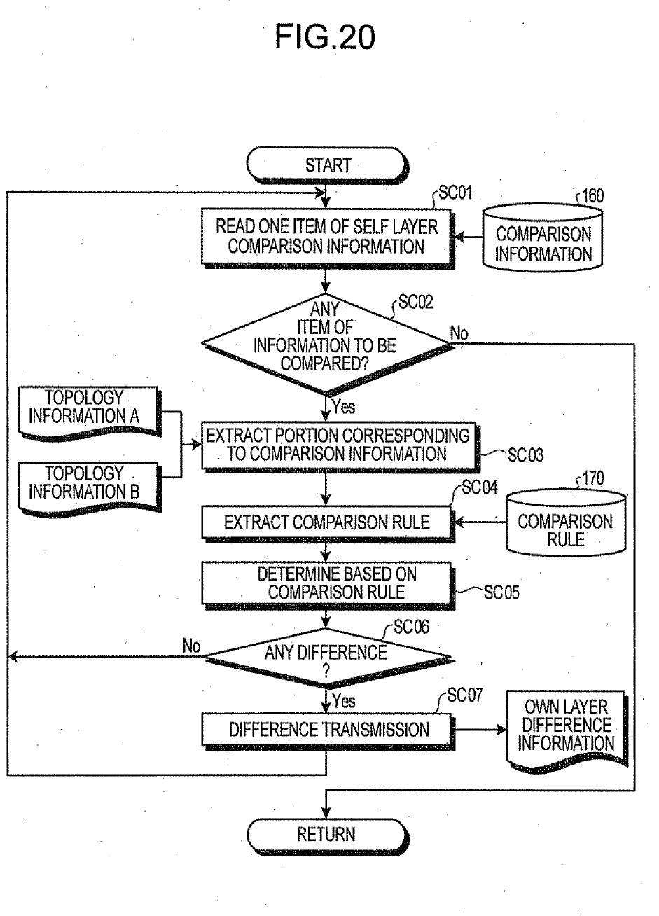

Subsequently, a description will be given of a processing procedure of the own layer difference extraction process shown in FIG. 19. FIG. 20 is a flowchart showing the processing procedure of the own layer difference extraction process shown in FIG. 19. As shown in FIG. 20, in the own layer difference extraction process, first, the difference extractor 132 retrieves one comparison item from the comparison information stored in the comparison information memory 160 (operation SC01).

Herein, the difference extractor 132 confirms whether or not all the comparison items have been compared in the comparison information and, if the comparison has already been carried out for all the comparison items, finishes the own layer difference extraction process (operation SC02, No). Contrarily, if there is any non-compared comparison item, the difference extractor 132 extracts information corresponding to the comparison item from the topology information A and the topology information B (operation SC03).

Subsequently, the difference extractor 132 extracts a comparison rule corresponding to the comparison item from the comparison rule information stored in the comparison rule memory 170 (operation SC04) and, based on the retrieved comparison rule, compares and determines the items extracted from the topology information A and the topology information B (operation SC05).

Herein, the difference extractor 132, if there is no difference as a result of the comparison and determination (operation SC06, No), returns to operation SC01, and carries out a comparison for next comparison items. Contrarily, if there is a difference as the comparison and determination result (operation SC06, Yes), the difference extractor 132, after transmitting the topology information, in which the difference has occurred, as the difference information (operation SC07), returns to operation SC01, and carries out a comparison for next comparison items.

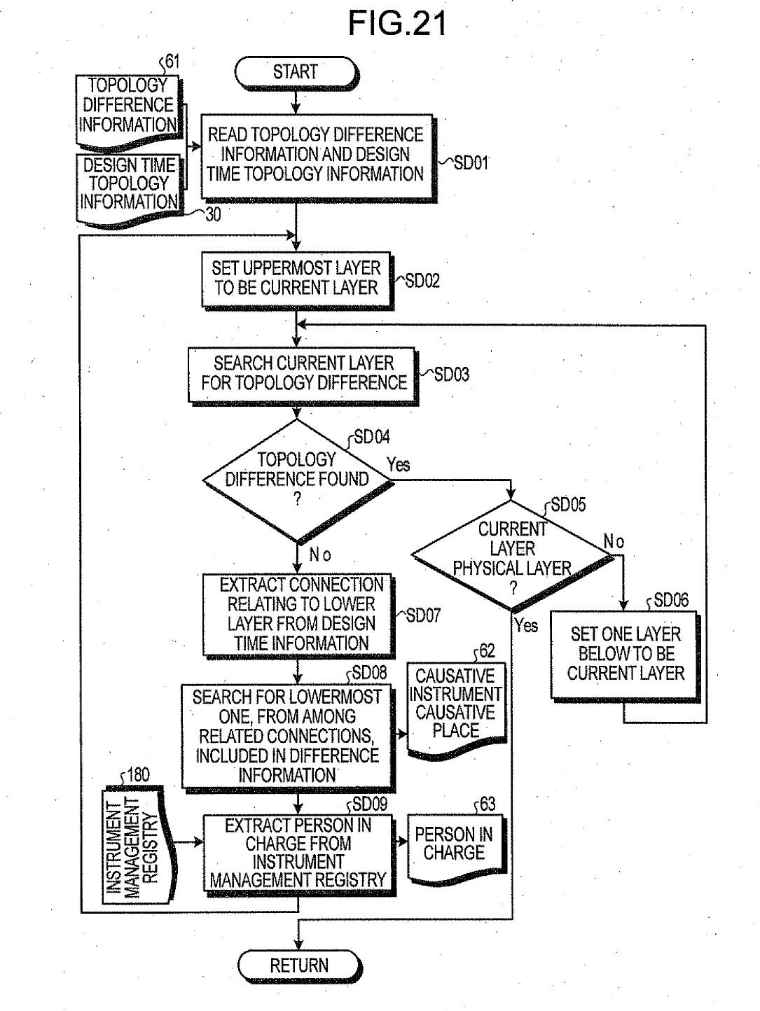

Subsequently, a description will be given of a processing procedure of the cause identification and person-in-charge extraction process shown in FIG. 19. FIG. 21 is a flowchart showing the processing procedure of the cause identification and person-in-charge extraction process shown in FIG. 19. As shown in FIG. 21, in the cause identification and person-in-charge extraction process, first, the cause identification and person-in-charge extraction portion 134 reads the topology difference information 61 and the design time topology 30 acting as a comparison reference (operation SD01).

Subsequently, the cause identification and person-in-charge extraction portion 134 sets an uppermost layer existing in the design time topology 30 to be a current layer acting as the search base point (operation SD02), searches the topology difference information 61, and extracts one difference in the current layer (operation SD03).

Herein, the cause identification and person-in-charge extraction portion 134, if the difference is found (operation SD04, Yes), determines whether or not the current layer is the physical layer and, if it is the physical layer (operation SD05, Yes), determines that there is no more lower layer, and finishes the cause identification and person-in-charge extraction process. Also, the cause identification and person-in-charge extraction portion 134, if the current layer is not the physical layer (operation SD05, No), sets one layer below the current layer to be the current layer (operation SD06), and returns to operation SD03.

Contrarily, if the difference in the current layer is not found (operation SD04, No), the cause identification and person-in-charge extraction portion 134 recursively searches a lower layer relating to a place in which the difference has occurred from the design topology 30, and groups the related places (operation SD07). Then, the cause identification and person-in-charge extraction portion 134 transmits a communication instrument and connection information, from among the related places, having the difference in the lowermost layer, as the causative instrument and causative place 62 (operation SD08). Furthermore, the cause identification and person-in-charge extraction portion 134 obtains a person in charge of the causative instrument from the instrument management registry memory 180, and transmits it as the person in charge 63 (operation SD09).

As above, the processing procedure of the topology comparator 130 has been described. In this way, the topology comparator 130, by comparing the design time topology 30 generated based on the design time setting information, and the post construction topology 40 generated based on the setting information acquired from the constructed network 200, carries out a verification of a manual instrument setting operation at the network construction time.

Also, the topology comparator 130, based on the setting information regularly acquired from the constructed network 200, by comparing the operation time topologies 50 generated at every differing time point, verifies that the setting of each communication instrument has been changed after the network operation start.

As described heretofore, in the embodiment, the design time topology calculator 110, based on the layer-by-layer design information 10 and physical connection information 20 set in each communication instrument, generates the layer-by-layer design time topology 30 of the network. Also, the post construction topology calculator 120 collects the layer-by-layer setting information actually set in each communication instrument and, based on the collected setting information, generates the layer-by-layer post construction topology 40 of the actually constructed network 200. In addition, the topology comparator 130 compares the design time topology 30 and the post construction topology 40 on the layer-by-layer basis. By these means, in the network configuration verification apparatus of the embodiment, it being possible to verify the topologies on the layer-by-layer basis, it is possible to comprehensively verify the whole network.

Also, in the embodiment, the design time topology calculator 110, based on the layer-by-layer design information, predicts and generates the instrument setting information which is dynamically set in the communication instrument in the case in which the network has actually been constructed, while the post construction topology calculator 120, in the actually constructed network, collects the setting information including the instrument setting information dynamically set after the construction and, based on the collected setting information, generates the layer-by-layer instrument setting information of the actually constructed network. Therefore, it is possible to comprehensively verify the whole network, including the setting information dynamically set for the communication instrument after the network construction.

Although the network configuration verification apparatus is described in the embodiment, it is possible, by realizing a function of the network configuration verification apparatus by means of software, to obtain a network configuration verification program having a similar function. Therein, in the following description, a description will be given of a computer which executes the network configuration verification program of the embodiment.

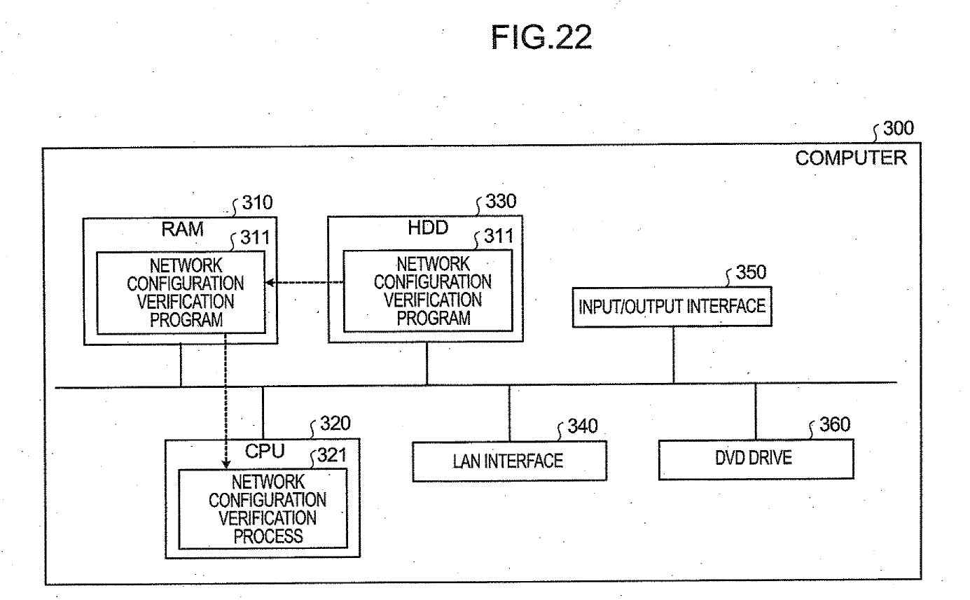

FIG. 22 is a functional block diagram showing a configuration of the computer which executes the network configuration verification program according to the embodiment. As shown in FIG. 22, the computer 300 has a RAM (Random Access Memory) 310, a CPU (Central Processing Unit) 320, an HDD (Hard Disk Drive) 330, a LAN (Local Area Network) interface 340, an input/output interface 350 and a DVD (Digital Versatile Disk) drive 360.

The RAM 310 is a memory which stores a program, a program execution intermediate result and the like, and the CPU 320 is a central processing unit which reads the program from the RAM 310 and executes it.

The HDD 330 is a disk drive which stores a program and data, and the LAN interface 340 is an interface for connecting the computer 300 to another computer via a LAN.

The input/output interface 350 is an interface for connecting an input device, such as a mouse and a keyboard, and a display device, and the DVD drive 360 is a drive which carries out a reading and writing of a DVD.

Then, the network configuration verification program 311 executed in the computer 300 is stored in the DVD, read from the DVD by the DVD drive 360, and installed in the computer 300.

Alternatively, the network configuration verification program 311 is stored in databases of other computer systems connected via the LAN interface 340, or the like, read from the databases, and installed in the computer 300.

Then, the installed network configuration verification program 311 is stored in the HDD 330, read out to the RAM 310, and executed as a network configuration verification process 321 by the CPU 320.

Apart from this, information including the processing procedures, control procedures, specific appellations, and various data and parameters, shown in the heretofore described documents and drawings, can be optionally changed if not otherwise specified.

Furthermore, all or any of processing functions carried out by the individual devices can be realized by a CPU and a program analyzed and executed by the CPU, or can be realized as hardware of a wired logic.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A medium having recorded therein a network configuration verification program, causing a computer to execute the following programs:
a. a topology design information generation procedure which, based on design information storing setting information, which is set in each communication instrument in order to enable a communication, on a layer-by-layer basis, generates layer-by-layer topology design information of a network;
b. a topology information generation procedure which collects the layer-by-layer setting information actually set in each communication instrument and, based on the collected setting information, generates layer-by-layer topology information of the network; and
c. a topology information comparison procedure which compares the topology design information generated by the topology design information generation procedure, and the topology information generated by the topology information generation procedure, on the layer-by-layer basis.

2. The medium having recorded therein the network configuration verification program according to claim 1, wherein
the topology design information generation procedure, based on the layer-by-layer topology design information, generates topology design information including information of a communication path which is constructed by an exchange of control information in a case in which the network is actually constructed, and
the topology information generation procedure collects setting information including the information of the communication path constructed by the exchange of the control information in the actually constructed network and, based on the collected setting information, generates layer-by-layer topology information of the actually constructed network.

3. The medium having recorded therein the network configuration verification program according to claim 1, wherein
the topology design information generation procedure generates topology design information of an upper layer by grouping lower layers,
the topology information generation procedure generates topology information of the upper layer by grouping the lower layers, and
the topology information comparison procedure, in the event that a mismatch is detected between the topology design information and the topology information in a certain layer, detects whether or not there is any mismatch between the topology design information and the topology information in a lower layer below the layer.

4. A medium having recorded therein a network configuration verification program causing a computer to carry out a process of verifying topologies of a network configured by connecting a plurality of communication instruments which carry out a communication using a communication protocol hierarchized in a plurality of layers, causing the computer to execute the following processes:
a. a topology information generation procedure which collects layer-by-layer setting information actually set in each communication instrument and, based on the collected setting information, generates layer-by-layer topology information of the actually constructed network;
b. a topology information regeneration procedure which re-collects the setting information after the layer-by-layer topology information is generated by the topology information generation procedure and, based on the re-collected setting information, regenerates the layer-by-layer topology information; and
c. a topology information recomparison procedure which compares the topology information generated by the topology information generation procedure, and the topology information regenerated by the topology information regeneration procedure, on a layer-by-layer basis.

5. A network configuration verification method in which a computer executes a process of verifying topologies of a network configured by connecting a plurality of communication instruments which carry out a communication using a communication protocol hierarchized in a plurality of layers, the computer executing the following processes:
a. a topology design information generation process which, based on design information storing setting information, which is set in each communication instrument in order to enable the communication, on a layer-by-layer basis, generates layer-by-layer topology design information of the network;
b. a topology information generation process which collects the layer-by-layer setting information actually set in each communication instrument and, based on the collected setting information, generates layer-by-layer topology information of the actually constructed network; and
c. a topology information comparison process which compares the topology design information generated by the topology design information generation process, and the topology information generated by the topology information generation process, on the layer-by-layer basis.

6. The network configuration verification method according to claim 5, wherein
the topology design information generation process, based on the layer-by-layer topology design information, generates topology design information including information of a communication path which is constructed by an exchange of control information in a case in which the network is actually constructed, and
the topology information generation process collects setting information including the information of the communication path constructed by the exchange of the control information in the actually constructed network and, based on the collected setting information, generates layer-by-layer topology information of the actually constructed network.

7. The network configuration verification method according to claim 5, wherein
the topology design information generation process generates topology design information of an upper layer by grouping lower layers,
the topology information generation process generates topology information of the upper layer by grouping the lower layers, and
the topology information comparison process, in the event that a mismatch is detected between the topology design information and the topology information in a certain layer, detects whether or not there is any mismatch between the topology design information and the topology information in a lower layer below the layer.

8. A network configuration verification method in which a computer executes a process of verifying topologies of a network configured by connecting a plurality of communication instruments which carry out a communication using a communication protocol hierarchized in a plurality of layers, the computer executing the following processes:
a. a topology information generation process which collects layer-by-layer setting information actually set in each communication instrument and, based on the collected setting information, generates layer-by-layer topology information of the actually constructed network;
b. a topology information regeneration process which re-collects the setting information after the layer-by-layer topology information is generated by the topology information generation process and, based on the re-collected setting information, regenerates the layer-by-layer topology information; and
c. a topology information recomparison process which compares the topology information generated by the topology information generation process, and the topology information regenerated by the topology information regeneration process, on a layer-by-layer basis.

9. A network configuration verification apparatus which verifies topologies of a network configured by connecting a plurality of communication instruments which carry out a communication using a communication protocol hierarchized in a plurality of layers, comprising:
a. a topology design information generator which, based on design information storing setting information, which is set in each communication instrument in order to enable the communication, on a layer-by-layer basis, generates layer-by-layer topology design information of the network;
b. a topology information generator which collects the layer-by-layer setting information actually set in each communication instrument and, based on the collected setting information, generates layer-by-layer topology information of the actually constructed network; and
c. a topology information comparator which compares the topology design information generated by the topology design information generator, and the topology information generated by the topology information generator, on the layer-by-layer basis.

10. The network configuration verification apparatus according to claim 9, wherein
the topology design information generator, based on the layer-by-layer topology design information, generates topology design information including information of a communication path which is constructed by an exchange of control information in a case in which the network is actually constructed, and
the topology information generator collects setting information including the information of the communication path constructed by the exchange of the control information in the actually constructed network and, based on the collected setting information, generates layer-by-layer topology information of the actually constructed network.

11. The network configuration verification apparatus according to claim 10, wherein
the topology design information generator generates topology design information of an upper layer by grouping lower layers;
the topology information generator generates topology information of the upper layer by grouping the lower layers, and
the topology information comparator, in the event that a mismatch is detected between the topology design information and the topology information in a certain layer, detects whether or not there is any mismatch between the topology design information and the topology information in a lower layer below the layer.

12. A network configuration verification apparatus which verifies topologies of a network configured by connecting a plurality of communication instruments which carry out a communication using a communication protocol hierarchized in a plurality of layers, comprising:
a. a topology information generator which collects layer-by-layer setting information actually set in each communication instrument and, based on the collected setting information, generates layer-by-layer topology information of the actually constructed network;
b. a topology information regenerator which re-collects the setting information after the layer-by-layer topology information is generated by the topology information generator and, based on the re-collected setting information, regenerates the layer-by-layer topology information; and
c. a topology information recomparator which compares the topology information generated by the topology information generator, and the topology information regenerated by the topology information regenerator, on a layer-by-layer basis.
